(19) United States
(12) Patent Application Publication
(10) Pub. No.: US 2022/0007579 A1
(43) Pub. Date: Jan. 13, 2022

(54) Terrain riding side - mounted weed trimmer riding frame apparatus

(71) Applicant: Jeffrey Michael Guarniere, Ninety Six, SC (US)

(72) Inventor: Jeffrey Michael Guarniere, Ninety Six, SC (US)

(21) Appl. No.: 17/300,278

(22) Filed: May 11, 2021

Related U.S. Application Data
(60) Provisional application No. 63/102,844, filed on Jul. 7, 2020.

(51) Int. Cl. A01D 43/16; A01D 34/416; A01D 34/64

(52) U.S. Cl. CPC A01D 43/16; A01D 2101/00; A01D 34/64; A01D 34/4165

(57) ABSTRACT

The present invention relates to a multi component apparatus, allowing user to couple a weed trimmer easily to a zero turn riding lawn mower, for trimming weeds that the mower cannot access. Apparatus can be mounted to the frame or foot rest of mower, apparatus wheel castors allow trimmer to ride the terrain.

### BACKGROUND OF THE INVENTION

A weed trimmer is used to trim or cut lengthy grass or weeds missed by a lawn mower.

This includes around fences, post, under bushes, around trees, along sides of houses and border edges. The user will hold weed trimmer while performing these tasks. Most users will tell you this is hard on the back, neck, shoulders, arms, neck and legs.

Inventors have tried to find a way to drive a lawn mower and weed trim at the same time, saving time and body pain.

What I have observed is they all are very costly apparatuses and they will not perform right. Their inventions also all couple to the mower deck which is not recommended by factory standards.

### SPECIFICATION

This apparatus couples to a zero turn lawn mower. The apparatus is a hinged mounting bracket that couples to the lawn mower. Said apparatus has two springs coupled to the hinge plate and a hinged shaft collar. The hinged collar shaft couples to a weed trimmer which allows weed trimmer to be easily connected and disconnected. The springs and mount hinge allow weed trimmer to move in any direction then back to stationary.

Two wheel castors are coupled to weed trimmer plastic weed guard to allow weed trimmer to easily ride on the terrain.

### DETAILED DESCRIPTION OF INVENTION

Referring to FIGS. 1,2,3, This (1) apparatus is for (10) weed trimmers to be coupled to a (9) zero turn lawn mower frame or foot rest deck.

The invention consist of a (2) hinged shaft collar which allows coupled (10) weed trimmer to move in any direction then back to stationary.

The apparatus has (11) castor wheels that couple to most (12) plastic weed guards of said (10) weed trimmers, which allows (10) weed trimmer to easily ride the terrain for a even cut.

The hinged (5) shaft collar allows user to easily install and disconnect (10) weed trimmer for manual use.

The (1) apparatus has a (8) hinge pin to keep (2) hinged spring plate coupled to (1) mounting bracket, which allows (10) weed trimmer to move up and down with the terrain.

The present invention has been described in detail with references to other versions. This invention is simple with not many part to it, yet the apparatus solves problems seen in other inventions.

### REFERENCES CITED

U.S. Pat. No. 8,973,343 B2 Mar. 10, 2015 Frank Bell Pottersville, Mo.
   56/10.4
U.S. Pat. No. 8,302,372 B1 Nov. 6, 2012 Jay Eubanks Sangor, Tex.
   56/12.7
U.S. Pat. No. 6,474,053 B1 Nov. 5, 2002 David M. Lund Detroit Lakes, Minn.
   56/13.7
U.S. Pat. No. 6,779,325 B1 Aug. 24, 2004 James F. Robillard II Musella, Ga.
   56/12.7
U.S. Pat. No. 6,601,374 B2 Aug. 5, 2003 Bruce R. Smith Bethany, Okla. 56/13.6

### BRIEF DESCRIPTION OF DRAWINGS

This is a multi apparatus explained in FIGS. 1,2,3 each drawing will be briefly explained.

FIG. 1 is a view of the whole apparatus from the left side of the zero turn riding mower, showing how the weed trimmer couples to said mower, said trimmer rests on terrain with coupled wheel castors.

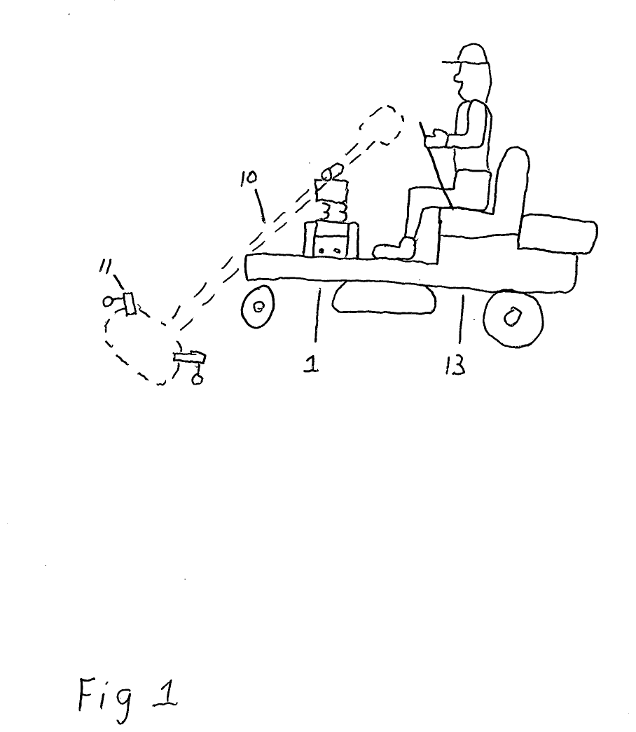

FIG. 2 is a view of one part of the apparatus showing how the existing weed trimmer, weed guard couples to castor wheels for easy mobility on the terrain.

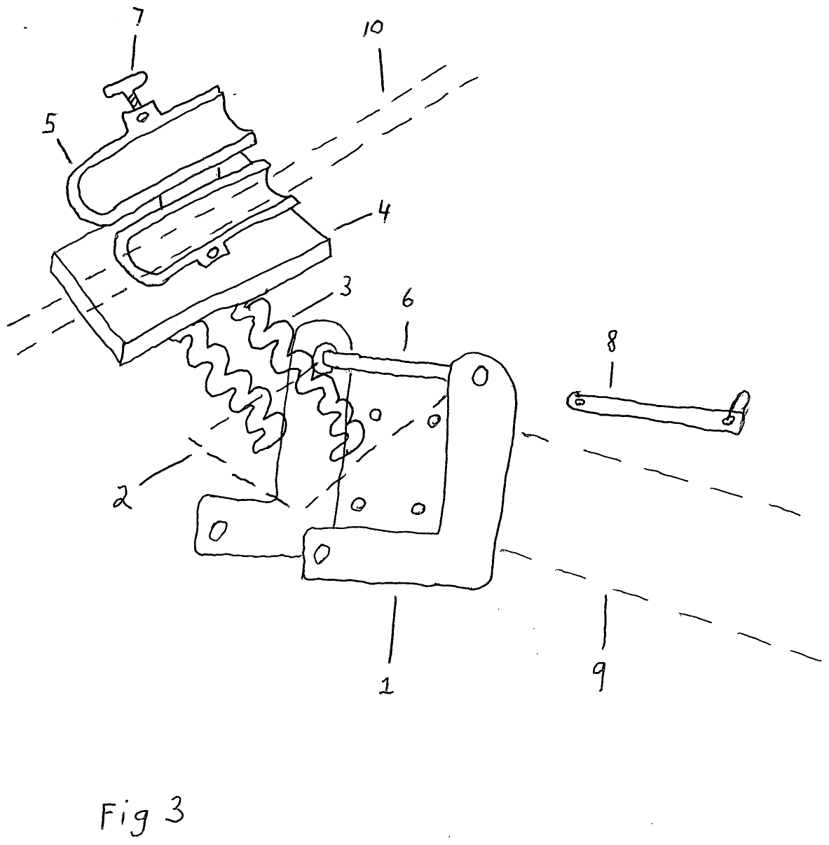

FIG. 3 is a view of the apparatus and frame of zero turn mower. Close up view of how hinges spring bracket and hinged shaft collar couple with weed trimmer shaft, also how hinge couples with mounting bracket and how mounting bracket couples with zero turn mower frame.

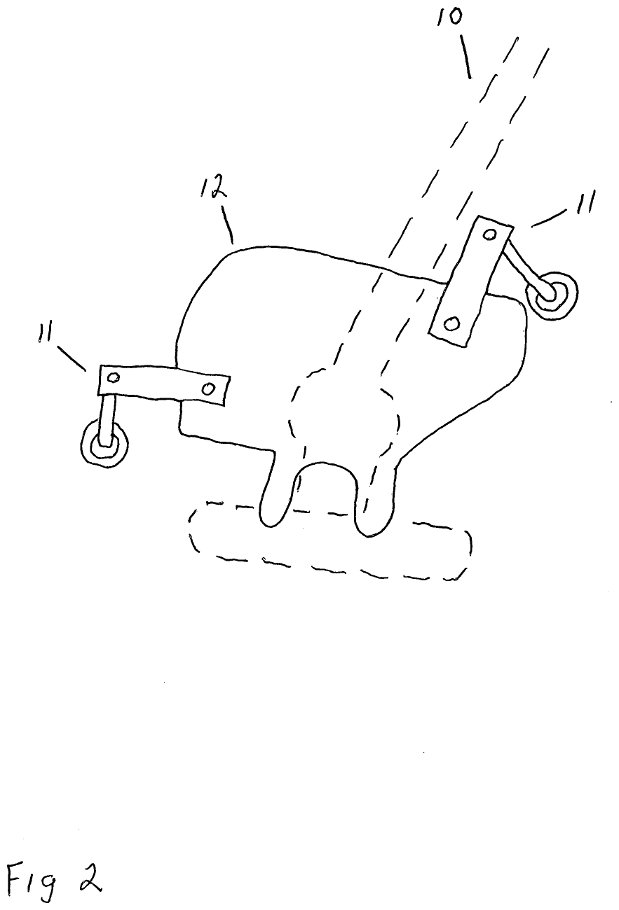

### SUMMARY OF THE INVENTION

Present invention is an apparatus that couples a weed trimmer to a zero turn riding lawn mower. Said invention has an L shaped mounting bracket than can couple to either mower frame or foot rest deck.

Said invention has a hinged spring plate which allows weed trimmer to move in any direction when weed trimmer comes in contact with objects. Said invention has a hinges shaft collar which allows user to couple any weed trimmer to apparatus and easily remove trimmer for manual use.

Said invention has wheel castor that will couple to most weed trimmers plastic weed guards for even cuts on rough terrain.

Said invention has a hinges plate that can easily be uncoupled from base mount bracket by removing one pin for easy transport of weed trimmer. Weed trimmers run on their own power whether it's gas or battery powered.

### DESCRIPTION OF PREVIOUS ART

In prior art (U.S. Pat. No. 6,779,325 B1) Robillard II

In prior art (U.S. Pat. No. 6,474,053 B1) Lund

In prior art (U.S. Pat. No. 8,973,343 B2) Bell

The devices couples to the mower deck, which is not recommended by the factory. The weight may cause damage to the parts of the mower deck.

The prior art as mentioned will not adjust to different heights in the terrain without a manual control.

The prior art as mentioned will not couple with any weed trimmer on the market.

The prior art cannot be used manually.

My recent art has advantages the prior art does not have. The apparatus I describe in recent art couples to frame or foot rest deck, which alleviates damage to the mower deck. The recent art apparatus has a pivoting spring hinge and weed guard coupled wheel castors which allow weed trimmer to ride with the terrain.

The recent art for said apparatus has a hinges shaft collar which allows user to couple any weed trimmer to apparatus and disengage for for manual use of weed trimmer. Recent art of apparatus also allows user to flip hinged spring plates and weed trimmer onto foot rest deck for transport.

1. The claimed invention is a hinged bracket mount that couples to a zero turn riding lawn mower frame or foot rest deck. I claim that the universal hinged shaft collar on the bracket mount will couple with any weed trimmer on the market.

2. I claim the terrain riding castor wheels will couple to most weed trimmers plastic weed guard.

3. I claim the bracket mount springs and hinge plate will allow weed trimmer to move up and down, left and right, back and forward, then back to stationary while riding the terrain.

4. I claim the hinged plate on the mounting bracket will allow user to rest weed trimmer on foot rest deck for transport between jobs.

5. I claim my weed trimmer apparatus will allow user to trim weeds hands free while driving zero turn riding mower.

6. I claim this invention will allow user to easily disconnect weed trimmer from hinged shaft collar for manual use.
